(19) United States
(12) Patent Application Publication
(10) Pub. No.: US 2025/0180496 A1
(43) Pub. Date: Jun. 5, 2025

(54) MANIPULATOR HEAD AND VACUUM SYSTEM

(71) Applicant: SPECS SURFACE NANO ANALYSIS GMBH, Berlin (DE)

(72) Inventors: Kai KUNZE, Berlin (DE); David SCHUMACHER, Berlin (DE); Karsten DIERSCHKE, Berlin (DE)

(21) Appl. No.: 18/837,672

(22) PCT Filed: Feb. 13, 2023
(86) PCT No.: PCT/DE2023/100119

§ 371 Date: Aug. 12, 2024

(30) Foreign Application Priority Data
Feb. 14, 2022 (DE) 10 2022 103 442.9

(51) Int. Cl. G01N 23/2204; G01N 23/2273

(52) U.S. Cl. CPC G01N 23/2204; G01N 23/2273; G01N 2223/307; G01N 2223/637

(57) ABSTRACT

The invention relates to pumping liquids (18) in a vacuum system at a negative pressure, in particular at an absolute pressure of below 600 mbar. For this purpose, a manipulator head (10′) is provided for use in a vacuum housing at a negative pressure. The manipulator head (10′) contains a liquid cell (12) and a liquid pump (14). The liquid cell (12) has a liquid cell outlet (22) and an interior space (16) that is designed for negative pressure and designed to receive a liquid (18). The liquid pump (14) has a liquid pumping region (26) which is fluidically connected to the fluid cell outlet (22) and is designed to pump the liquid (18) out of the liquid pumping region (26) when there is negative pressure in the interior space (16) of the liquid cell (12). A distance (d′) between the liquid cell outlet (22) of the liquid cell (12) and the liquid pumping region (26) of the liquid pump (14) is selected such that at an absolute pressure of below 600 mbar in the interior space (16) of the liquid cell (12), the liquid (18) extends at least as far as the liquid pumping region (26) of the liquid pump (14), so that the latter can pump the liquid (18). This makes it possible to construct a compact vacuum system that can circulate liquid (18) at an absolute pressure of below 600 mbar and in particular can also be drained.

### FIELD OF THE INVENTION

The invention relates to a manipulator head for use in a vacuum housing at a negative pressure, a manipulator with the manipulator head, a vacuum system with the manipulator head, as well as a manufacturing method for the manipulator head, a method for operating the vacuum system and uses of the vacuum system and the method for operating the vacuum system. In particular, the invention relates to filling and emptying an electrochemical cell at an absolute pressure of below 600 mbar, for example below 400 mbar, in particular 100 mbar or less.

### PRIOR ART

From the operating manual V. 1.0 dated Jun. 2, 2020 for the product O-EC-NAP Operando Electrochemical Cell from SPECS Surface Nano Analysis GmbH, a vacuum system is known in which an electrochemical cell is arranged in a vacuum housing in order to be able to carry out measurements on the electrochemical cell at a negative pressure. The electrochemical cell is filled with a water-based electrolyte so that measurements can be performed on a sample electrode as well as on the water-based electrolyte. To empty the water-based electrolyte from the electrochemical cell, a peristaltic pump is arranged outside the vacuum housing, which pump can pump the water-based electrolyte out of the electrochemical cell at absolute pressures above 600 mbar in the vacuum housing. To empty the cell, the absolute pressure in the vacuum housing is increased until the water-based electrolyte can be pumped out of the electrochemical cell.

WO 01/16486 A1 shows a peristaltic pump with a pumping mechanism within a vacuum chamber. Placing the pumping mechanism within a vacuum chamber reduces the differential pressure between the inside and outside of the pumping channel, thereby minimizing changes in the enclosed fluid volume.

### DESCRIPTION OF THE INVENTION

It can be regarded as an object of the invention to provide a manipulator head, a manipulator with the manipulator head and a vacuum system with the manipulator head, as well as a corresponding manufacturing method for the manipulator head and a method for operating the vacuum system with the manipulator head, which make it possible to pump liquid at an absolute pressure of below 600 mbar.

According to a first aspect of the invention, a manipulator head is provided which is configured for use in a vacuum housing at a negative pressure. The manipulator head has a liquid cell and a liquid pump. The liquid cell has a liquid cell outlet and an interior space configured for negative pressure and configured to receive a liquid. The liquid pump has a liquid pumping region fluidically connected to the liquid cell outlet and is configured to pump the liquid from the liquid pumping region when there is a negative pressure in the interior space of the liquid cell. A distance between the liquid cell outlet of the liquid cell and the liquid pumping region of the liquid pump is selected such that at an absolute pressure of below 600 mbar, for example below 400 mbar, in particular of 100 mbar or less, the liquid extends in the interior space of the liquid cell at least into the liquid pumping region of the liquid pump, so that the latter can pump the liquid.

Negative pressure is to be understood here as an absolute pressure that is below atmospheric pressure, i.e., a negative pressure is an absolute pressure below atmospheric pressure, e.g., below 1013.25 mbar, or 1 atm. The negative pressure in the interior of the liquid cell can, for example, be an absolute pressure between 0.1 mbar and up to below 600 mbar. Preferably, the absolute pressure in the interior space of the liquid cell can be between 0.1 mbar and 100 mbar.

The interior space of the liquid cell can be fluidically connected to an environment of the manipulator head, i.e., gases and liquids can be exchanged between the interior space of the liquid cell and the environment of the manipulator head. For this purpose, the liquid cell can, for example, have an opening to the surroundings of the manipulator head. This makes it possible, when the manipulator head is arranged in the vacuum housing, to set a pressure in the interior space of the liquid cell above an operating pressure within the vacuum housing.

The manipulator head can, for example, be arranged in a vacuum housing of a vacuum system that is operated close to the vapor pressure equilibrium of the liquid. This means that the pressure acting on the surface of the liquid, or the operating pressure, is specified at a fixed temperature. At such a low operating pressure, in vacuum systems known from the prior art—depending on other parameters such as density of the liquid, viscosity of the liquid, inner diameter of a liquid line between the liquid line outlet and the liquid pumping region or liquid line inner diameter for discharging the liquid, material of the liquid line, length of the liquid line, etc.—the liquid cannot flow away solely due to the operating pressure. If one wants to replace the liquid, the operating pressure in vacuum systems known from the prior art would have to be increased, which would lead to an interruption of operation, for example a measurement.

In order for the liquid pump to be able to pump out the liquid, the liquid must extend into the liquid pumping region of the liquid pump. The inventors have recognized that the operating pressure alone cannot ensure this if the distance is too great between the liquid cell outlet of the liquid cell of the vacuum system known from the prior art and the liquid pumping region of the liquid pump. In this case, the pressure loss of a line between the liquid cell outlet and the liquid pumping region of the liquid pump may be greater than the pressure pushing the liquid into the liquid pumping region.

Since the manipulator head has both the liquid cell and the liquid pump, a compact design can be achieved, whereby a smaller distance between the liquid cell outlet of the liquid cell and the liquid pumping region of the liquid pump can be achieved. This reduces the opposing forces against the liquid that prevent the liquid from extending into the liquid pumping region of the liquid pump. In particular, a pressure loss along a liquid line between the liquid cell outlet of the liquid cell and the liquid pumping region of the liquid pump can be reduced if the distance between them is smaller and thus the liquid line between the liquid cell outlet and the liquid pumping region is also shorter. The pressure loss is caused in particular by frictional forces between the liquid and the liquid line. A pressure loss along the liquid line can be reduced to such an extent that pumping of liquid by the liquid pump is possible even when the absolute pressure acting on the liquid is below 600 mbar, for example below 400 mbar, such as 100 mbar or less, in particular between 0.1 mbar and 100 mbar, e.g., between 10 mbar and 100 mbar. This allows the liquid to be pumped, and thus exchanged, at an absolute pressure of below 600 mbar, for example 100 mbar or less, during operation of the manipulator head and in particular the liquid cell, without a higher pressure having to be generated in the vicinity of the manipulator head to enable pumping. This can also allow the liquid cell to be drained. Since it is not necessary to break the negative pressure to exchange the liquid, the ingress of dirt into the environment around the manipulator head and in particular into the liquid cell can be prevented or at least reduced. This enables improved operation of the manipulator head. For example, the liquid can be pumped and, for example, exchanged without increasing the pressure even when the manipulator head and in particular the liquid cell are operating in vapor pressure equilibrium of the liquid. Furthermore, measurement at one point is possible at different liquid levels in the liquid cell, since liquid can be added or removed from the liquid cell at the desired operating pressure. For example, when the manipulator head is used in a negative pressure system with an illumination system and a detector system to analyze a sample, the sample can be analyzed in a non-wetted state, a wetted state, and a state with different thicknesses of liquid film on the surface of the sample without having to change the location to be measured on the sample.

Since the distance between the liquid cell outlet of the liquid cell and the liquid pumping region of the liquid pump is selected such that, at a negative pressure of below 600 mbar, in particular of 100 mbar or less, the liquid extends at least into the liquid pumping region of the liquid pump in the interior space of the liquid cell, the liquid can also be pumped for different liquids and different operating parameters of the liquid cell.

Extending into the liquid pumping region of the liquid pump so that the liquid pump can pump the liquid is understood to mean that the liquid extends far enough into the liquid pump that pumping elements can act to pump the liquid. For example, pump elements can be pressing elements, such as rollers or sliding shoes of a peristaltic pump. In this case, the liquid must extend far enough into the liquid pump that liquid can be pumped by pressing a liquid line of the liquid pump using a pressing element and then moving the pressing element while the liquid line is pressed. In this case, the liquid pumping region starts behind the pressing position of the pressing element and the liquid must extend in the liquid line over the pressing position of the pressing element so that the liquid pump can pump the liquid.

In the case of a negative pressure in the interior space of the liquid cell, the pressure acting on the liquid can in principle be so low that the pressure loss along a liquid line between the liquid cell outlet of the liquid cell and the liquid pumping region of the liquid pump is greater than the pressure pressing the liquid in the direction of the liquid pumping region. In this case, the distance from the liquid cell outlet to the liquid pumping region cannot be overcome by the liquid, so that the liquid does not reach the liquid pumping region, or at least does not extend far enough into the liquid pump for the pump to be able to pump the liquid. In this case, liquid cannot be pumped out of the liquid cell in order to empty it. In other words, in this case the pressure generated by the liquid column of a few cm, i.e., a few mbar hydrostatic pressure and possibly a dynamic pressure by pumping liquid into the interior space, can be lower than the pressure loss along the liquid line. If the liquid line is shortened, then from a certain length the pressure loss becomes less than the pressure acting on the liquid, so that the liquid extends up to the liquid pumping region and the liquid can be pumped.

The pressure loss Δp₁₂ between a first position of the liquid line, for example a liquid line inlet, and a second position of the liquid line, for example the pressure position of the pressing element, can be determined for example based on the Darcy-Weisbach equation as

$$Δ {p}_{12} = \frac{ρ \cdot {u}^{2}}{2} ( λ \cdot \frac{l}{d} + \sum {ζ}_{i} )$$

where ρ is the density of the liquid, u the flow velocity of the liquid, λ the pipe friction coefficient, l the length of the liquid line between the first position and the second position and d the liquid line inner diameter, as well as optionally a pressure loss coefficient ζᵢ for shaped parts, such as bends or reducers. If the liquid line inner diameter and its material and the flow velocity are specified, for example by design constraints, the pressure loss can be adjusted via the length of the liquid line. A liquid line volume can advantageously be minimized by choosing the liquid line inner diameter and the length of the liquid line to be as small as possible. This can, for example, make it possible to reduce the dead volume of the liquid, so that the flow time through the liquid line can be reduced, particularly when the liquid is exchanged. Furthermore, the amount of liquid flowing through the liquid line can be reduced, so that operating costs can be reduced, especially for expensive liquids.

The total pressure pₜₒₜ acting in a liquid line can be determined for stationary flows of viscosity-free incompressible fluids using the Bernoulli pressure equation: pₜₒₜ=p_{dyn}+pₛₜₐₜ with the dynamic pressure p_{dyn}=ρ/2·u² and the static pressure pₛₜₐₜ=p+ρ·g·h, which is composed of the operating pressure p and the hydrostatic pressure of the fluid column p_{g}=ρ·g·h, where g is the acceleration due to gravity and h is the height of the liquid column. Furthermore, other pressures, for example in case of compressibility of the liquid, the viscosity of the liquid and/or the capillarity of the liquid line, can be taken into account in the Bernoulli pressure equation. Using the Bernoulli pressure equation and the Darcy-Weisbach equation, a maximum length of the liquid line can then be estimated for which the total pressure is greater than the pressure loss, and the distance between the liquid cell outlet and the liquid pumping region of the liquid pump can be chosen accordingly so that the liquid extends into the liquid pumping region of the liquid pump and the liquid can be pumped.

The person skilled in the art can also determine, for example by simple experimentation, the distance between the liquid cell outlet of the liquid cell and the liquid pumping region of the liquid pump for which, at an absolute pressure of below 600 mbar, the liquid extends into the liquid pumping region. For this purpose, for example, for liquid lines with identical liquid line inner diameter and different lengths, it can be tested for which liquid lines the liquid extends into the liquid pumping region of the liquid pump so that the liquid can be pumped. This makes it possible to take into account parameters of the vacuum system in which the manipulator head is arranged, such as a viscosity of the liquid, a liquid cell outlet diameter, a liquid line inner diameter, a liquid pumping region diameter, and other parameters.

The distance between the liquid cell outlet and the liquid pumping region can be a vertical distance, a horizontal distance, or a combination of vertical and horizontal distance. By providing a vertical distance between the liquid cell outlet and the liquid pumping region, an additional gravitational force acts on the liquid so that additional pressure can be generated in order to push the liquid into the liquid pumping region. This can, for example, also make it possible to counteract adhesion forces. In other words, the provision of a vertical distance can generate a gravitational force on the liquid so that even at an absolute pressure of below 600 mbar, a positive force acts on the liquid, pushing the liquid into the liquid pumping region so that adhesion forces of the liquid line can be overcome.

The liquid line can be made of a material that is not compressible at atmospheric pressure. The material is considered to be incompressible if an internal diameter of a liquid line decreases by less than 5% under an atmospheric pressure acting on the liquid line from the outside, if a negative pressure, for example of below 600 mbar, in particular of 100 mbar or less, prevails within the liquid line. The material of the liquid line is preferably vacuum-compatible, chemically resistant and inert. The material can contain or be, for example, steel or plastic, such as polyetheretherketone (PEEK) or polytetrafluoroethylene (PTFE). The liquid line can, for example, be a steel line whose inner wall is coated with a plastic such as PEEK or PTFE. Alternatively, the liquid line can also be made of an elastic material so that the liquid line can be clamped off. The liquid line can, for example, be a PEEK tube.

The liquid line can be configured in such a way that it does not collapse when atmospheric pressure acts on the liquid line from the outside, or that the liquid line inner diameter is reduced by less than 5% when an absolute pressure of for example below 600 mbar, in particular of 100 mbar or less, prevails within the liquid line. For this purpose, for example, a liquid line inner diameter, a liquid line outer diameter, a liquid line wall thickness and the material properties of the liquid line can be coordinated to one another accordingly.

The distance between the liquid cell outlet and the liquid pumping region can be, for example, between 0.1 mm and 200 mm, for example between 0.1 mm and 100 mm or between 1 mm and 40 mm. The liquid line can accordingly have a length between 0.1 mm and 200 mm, for example between 0.1 mm and 100 mm or 1 mm and 40 mm.

The liquid line can have a constant liquid line inner diameter, for example between 0.5 mm and 4 mm. This makes it possible to provide a thin liquid line, so that a compact design of the manipulator head is possible. In addition, a reduced volume for a lumen enclosed by the liquid line can be achieved. The liquid line inner diameter can be, for example, between 1 mm and 4 mm, for example 2 mm or 2.8 mm. A larger liquid line inner diameter also leads to a larger liquid line outer diameter, so that a compact design is not possible with a large liquid line inner diameter. A smaller liquid line inner diameter can create capillary effects. The inner diameter of the liquid line can be selected so that forces generated by capillary effects are small compared to other forces acting on the liquid. This can make it possible to reduce the adhesion forces in the liquid line.

The manipulator head can be an assembly of a liquid cell and liquid pump connected to one another, which can be housed together in a vacuum housing, the assembly of the liquid cell and liquid pump connected to one another can be fastened to a manipulator, or the assembly of the liquid cell and liquid pump connected to one another can be housed in the vacuum housing and fastened to the manipulator. In particular, the manipulator head can be a manipulator head for a manipulator, i.e., the manipulator head can be suitable for being fastened to a manipulator, in particular for being fastened to a manipulator.

The manipulator head can have a housing in which the liquid cell and the liquid pump are arranged. Alternatively, the liquid cell and the liquid pump can also be arranged in separate housings connected to one another.

The manipulator head can have a fastening device which is configured to be fastened to a manipulator. The fastening device can, for example, have a closure. The fastening device can also be only a surface with fastening means. For example, the fastening device can be a base of the manipulator head with threaded holes that can be placed on a surface of the manipulator and into whose threaded holes screws fastenable to the manipulator can be inserted to connect the manipulator head to the manipulator.

The liquid pump can also be connected directly to the liquid cell outlet, so that the distance between the liquid cell outlet and the liquid pumping region is very short, for example below 1 mm, in particular 0.5 mm or less.

The liquid line does not have to end at the liquid pumping region of the liquid pump. The liquid line can, for example, also extend beyond the liquid pumping region of the liquid pump, in particular if the liquid pump is a peristaltic pump in which the liquid line runs through the peristaltic pump.

The liquid cell outlet and the liquid pumping region can be arranged relative to one another in such a way that, at a negative pressure of below 600 mbar, in particular of 100 mbar or less, the liquid extends in the interior space of the liquid cell, solely by the action of gravity, at least as far as the liquid pumping region, so that the latter can pump the liquid.

The liquid cell outlet can be arranged in a bottom region of the liquid cell, in particular at a lowest point of the interior space of the liquid cell. The liquid cell outlet of the liquid cell can be arranged at a vertical distance from the liquid pumping region of the liquid pump that is selected such that, at an absolute pressure of below 600 mbar, for example below 400 mbar, in particular 100 mbar or less, the liquid extends in the interior space of the liquid cell at least into the liquid pumping region of the liquid pump, so that this pump can pump the liquid.

The bottom region can, for example, comprise the base of the liquid cell and/or a part of the wall of the liquid cell, in particular a part of the wall that is in contact with the base. The liquid cell outlet can be arranged at a lowest point of the interior space of the liquid cell. For example, the liquid cell outlet can be arranged in the wall of the liquid cell such that a lowest point of the liquid cell outlet forms a lowest point of the interior space of the liquid cell.

Since the liquid cell outlet of the liquid cell is arranged in the bottom region of the liquid cell, in particular at a lowest point of the interior space, the liquid can flow from the interior space into the liquid cell outlet. Since the liquid cell outlet of the liquid cell is arranged at a vertical distance from the liquid pumping region of the liquid pump, a gravitational force acts on the liquid between the liquid cell outlet of the liquid cell and the liquid pumping region of the liquid pump. The gravitational force acts in the direction opposite to forces that prevent the liquid from penetrating into the liquid pumping region of the liquid pump. Since the vertical distance is selected such that, at an absolute pressure of below 600 mbar, in particular of 100 mbar or less, the liquid extends at least into the liquid pumping region of the liquid pump in the interior space of the liquid cell, the liquid pump can pump the liquid. In other words, the vertical distance is chosen so that the gravitational force is stronger than all opposing forces that prevent the liquid from extending into the liquid pumping region.

The vertical distance can be, for example, between 1 mm and 200 mm, for example between 1 mm and 40 mm, in particular between 5 mm and 20 mm, for example 12 mm.

A base of the liquid cell can have an inclination in the direction of the liquid cell outlet. The inclination can be selected such that the liquid flows in the direction of the liquid cell outlet. This allows for improved drainage of liquid into the liquid cell outlet so that drainage from the liquid cell can be improved. The angle of inclination can, for example, be between 2° and 45° or between 2° and 20°. For example, the liquid cell outlet can be located on one side of the liquid cell or in the middle of the liquid cell.

The liquid pump can have a positive displacement pump, in particular a peristaltic pump. This allows for a simple construction of the manipulator head.

The peristaltic pump can have a housing that encloses the liquid line. The liquid line can be arranged on a wall of the housing. The housing can have a rotor and one or more pressing elements, such as rollers or sliding shoes. The rotor can be connected to this or to these and can drive them. The rollers or sliding shoes can be arranged in such a way that they can press or clamp off a portion of the liquid line during rotation of the rotor in order to pump the liquid in this way. For example, the rollers can have lubricant-free hybrid ball bearings. If the liquid pump is provided in the form of a peristaltic pump, the liquid line is preferably a hose that can be clamped off the rollers or sliding shoes of the peristaltic pump. The provision of a liquid pump in the form of a peristaltic pump enables a simple and robust design in which the parts in contact with the liquid, in particular a liquid line in the form of a hose, are easily exchangeable.

The liquid pump can also be or have, for example, a diaphragm pump, a piezo pump, an electro-osmosis pump or another type of positive displacement pump. The liquid pump can also be or have a microfluidic pump.

The liquid pump can have an inlet pressure of 0 mbar. The liquid pump can be made of one or more temperature-resistant materials, for example temperature-resistant up to over 150° C. or up to over 300° C., so that the liquid pump can be baked out.

The liquid pump can be made of ultra-high-vacuum-compatible (UHV-compatible) materials. The materials can have a very low vapor pressure, for example below 10⁻¹⁰ mbar at 150° C. down to an order of magnitude of below 10⁻⁸ a mbar at 130° C. The materials can be or contain, for example, stainless steel, aluminum or PEEK.

The liquid cell can be an electrochemical cell. The electrochemical cell can have a working electrode and a counter-electrode. This makes it possible to operate an electrochemical cell at a negative pressure of 600 mbar or less and to study its properties and behavior using a suitable analysis system. The working electrode can, for example, serve as a sample to be analyzed or measured. The liquid cell can have one or more additional electrodes, for example a reference electrode.

The liquid can, for example, contain a liquid electrolyte, e.g., water-based electrolyte, or be a liquid electrolyte, e.g., water-based electrolyte. Alternatively or additionally, the liquid can contain or be for example a water-based solution, an alcohol-based liquid, for example an alcohol such as glycol or ethanol, or an oil, such as engine oil, for example 5W40.

The working electrode can be arranged at an inclination to a liquid surface in the electrochemical cell. The inclination can for example be between 0.1° and 80°, in particular between 15° and 45°. The inclination can be selected such that a first part of the working electrode can protrude from the liquid during operation, a second part of the working electrode can be wetted by the liquid and a third part of the working electrode can be located within the liquid. The working electrode can be arranged at a fixed inclination relative to a housing wall of the electrochemical cell so that a fixed inclination to the liquid surface is established when the liquid cell is filled with the liquid. Alternatively, the working electrode can be arranged on an inclination device that can adjust an inclination angle of the working electrode relative to the housing wall of the electrochemical cell so that an inclination angle to the liquid surface can also be adjusted. Alternatively, or additionally, the electrochemical cell can be inclined so that the working electrode has an inclination towards the liquid surface. The electrochemical cell can be inclined, for example using a manipulator.

Since the working electrode can be arranged with an inclination relative to the liquid surface in the electrochemical cell, different measurements can be carried out with the working electrode, namely on the working electrode itself, on the working electrode when it is wetted by liquid, and on the liquid itself. Depending on the operation of the electrochemical cell, this may require little or no movement of the working electrode relative to a radiation spot or of the radiation spot relative to the working electrode.

The liquid cell can have a cover with an opening. The opening can have a size that ensures that the liquid in the liquid cell is fluidically connected to the environment of the manipulator head. For example, the opening can have an area between 1 mm² and 10 cm². The opening can be, for example, oval, circular, or rectangular. The cover makes it possible to prevent or at least reduce unintentional leakage of liquid from the liquid cell into the environment around the manipulator head. An inner side of the cover, which faces the liquid, can be coated. For example, a coating made of PTFE or PEEK can be provided.

An inner wall of the liquid cell can be made of a plastic, for example PEEK. The inner wall of the liquid cell can also be coated with PTFE or formed from PTFE.

The manipulator head can have a temperature control device. The temperature control device can contain one or more heaters and/or coolers. The temperature control device can be arranged on or in the liquid line, a liquid supply line, the liquid cell and/or the liquid pump. This makes it possible to control the temperature of the liquid, i.e., to heat or cool it, in order to set a desired temperature for the liquid at a specific position of the manipulator head. Different heating and cooling systems can also be provided at different positions on the manipulator head. This can make it possible to set different temperatures for the liquid at different positions of the manipulator head.

The manipulator head can have a buffer cell. The buffer cell can, for example, serve as a liquid reservoir, especially as an electrolyte reservoir. The buffer cell can, for example, be located below the liquid cell. The buffer cell can be configured to collect liquid escaping from the liquid cell. For example, the buffer cell can be open at the top and have a larger base area than the liquid cell in order to collect liquid leaking from the liquid cell. This makes it possible to collect any liquid that accidentally leaks out.

The buffer cell can be configured to serve as a vapor pressure buffer.

The temperature control device can further be configured to control the temperature of the buffer cell. One or more of the heaters and/or coolers of the temperature control device can, for example, be arranged on or in the buffer cell. This makes it possible, for example, to heat up the buffer cell. This makes it possible, for example, to establish a vapor pressure equilibrium between an electrolyte volume in the electrochemical cell and an electrolyte volume in the buffer cell if the liquid cell is an electrochemical cell and the liquid is an electrolyte. This can, for example, make it possible to keep an electrolyte level in the electrochemical cell constant. For this purpose, for example the temperature of the buffer cell can be changed slowly or carefully in order to equalize the vapor pressure equilibrium between the electrochemical cell and the buffer cell when they are operated in a vacuum housing at negative pressure.

The manipulator head can have or be connected to one or more liquid reservoirs. The liquid reservoirs can, for example, be arranged in a cavity of the vacuum housing. This allows liquid to be pumped from the liquid reservoir into the liquid cell. For example, the liquid pump or another pump can be used to pump the liquid from the liquid reservoir into the liquid cell. The liquid reservoirs can serve as vapor pressure buffers.

The manipulator head can have a distance adjustment device configured to adjust the distance between the liquid cell and the liquid pump. The distance adjustment device can include or be a height adjustment device. The height adjustment device can be configured to adjust the vertical distance between the base of the liquid cell and the liquid pumping region of the liquid pump.

Alternatively, the vertical distance can also be selected such that all liquids that are to be used in the operation of the manipulator head at negative pressure extend at least into the liquid pumping region of the liquid pump so that they can be pumped by this pump. This makes it possible to ensure that, at an absolute pressure of below 600 mbar, in particular of 100 mbar or less, in the interior space of the liquid cell, the liquid extends into the liquid pumping region of the liquid pump during operation of the manipulator head. Therefore, the distance and in particular the vertical distance can be adapted to the other conditions or parameters of the operation, for example the viscosity of the liquid and the liquid line inner diameter.

According to a further aspect of the invention, a manipulator is provided. The manipulator has a manipulator interior space. The manipulator is configured to be hermetically connected to a vacuum housing. In particular, a cavity enclosed by the vacuum housing can be hermetically connected to the manipulator interior space. The manipulator further has a movable shaft with a distal end. When the manipulator is connected to the vacuum housing, the distal end can be moved in a cavity of the vacuum housing. The distal end of the movable shaft has the manipulator head according to at least one of claims 1 to 6 or an embodiment of the manipulator head. In a state where the manipulator is connected to the vacuum housing, the manipulator head is therefore arranged in the cavity of the vacuum housing. This makes it possible to move the manipulator head in a vacuum housing in order to prepare the liquid cell, for example, in a first position, and to analyze it or carry out a measurement in a second position. For this purpose, the movable shaft can move the manipulator head from the first to the second position, for example under an analysis system.

At least part of the movable shaft can be arranged in the manipulator interior space. The manipulator can have a housing that encloses the manipulator interior space. The housing can, for example, be a hollow cylinder. The manipulator interior space can be a lumen. The movable shaft can be at least partially arranged within the lumen. The movable shaft can have a proximal end. When the manipulator is connected to the vacuum housing, the proximal end of the shaft can be arranged outside the vacuum housing, for example in the lumen of the manipulator. The proximal end of the shaft can also form a proximal end of the manipulator and be located outside the lumen of the manipulator. The housing of the manipulator can have one or more accesses into the lumen. Cables can be guided through the manipulator through the lumen and in particular in a shaft lumen enclosed by the movable shaft. The lines can comprise, for example, electrical lines and/or liquid lines. For example, the accesses can be located at or near the proximal end of the shaft.

The manipulator can be configured such that the distal end of the shaft can be moved in the vacuum housing and/or can be retracted behind a valve in the manipulator interior space. This allows a liquid cell located at the distal end of the shaft to be prepared with a sample at a first pressure and analyzed at a second pressure.

The movable shaft can also be rotatable. This can make it possible to incline the manipulator head.

For example, the shaft can have an outer diameter between 36 mm and 38 mm. For example, the lumen in which the shaft extends can have an inner lumen diameter between 38 mm and 40 mm.

According to a further aspect of the invention, a vacuum system is provided which has:
a vacuum housing for hermetically enclosing a first cavity at a negative pressure and
a manipulator head according to at least one of claims 1 to 6 or an embodiment of the manipulator head.

The manipulator head can be arranged in the first cavity of the vacuum housing. The vacuum system can be configured to generate an absolute pressure of below 600 mbar, for example below 400 mbar, in particular 100 mbar or less, in the first cavity. The vacuum system can, for example, have one or more pumps to generate the negative pressure in the first cavity.

According to a further aspect of the invention, a vacuum system is provided which has:
a vacuum housing for hermetically enclosing a first cavity at a negative pressure and
a manipulator according to claim 7 or an embodiment of the manipulator.

The manipulator can be hermetically connected to the vacuum housing. The manipulator head can be arranged in the first cavity of the vacuum housing. The vacuum system can be configured to generate an absolute pressure of below 600 mbar, for example below 400 mbar, in particular 100 mbar or less, in the first cavity. The vacuum system can, for example, have one or more pumps to generate the negative pressure in the first cavity.

The vacuum system according to claim 8 or 9 or an embodiment of the vacuum system can have an illumination system and a detector system. The illumination system can be configured to illuminate the liquid cell with particles or radiation. The detector system can be configured to receive particles or radiation emitted from the liquid cell.

The illumination system can have a radiation source, for example a radiation source for electromagnetic radiation, such as X-rays, synchrotron radiation, deep ultraviolet (DUV) radiation, or light. The illumination system can additionally have a monochromator for spectrally isolating a specific wavelength from an incident beam from the radiation source. Alternatively, or additionally, the illumination system can also include a particle source. This makes it possible to provide particles or radiation that can be used to illuminate the liquid cell.

The illumination system can be movable and/or capable of being inclined so that it can be moved towards the liquid cell, or a sample located in the liquid cell, in order to illuminate the liquid cell or the sample with the particles or radiation. Alternatively, or additionally, the detector system can be movable and/or capable of being inclined so that it can be moved toward the liquid cell in order to receive particles or radiation emitted from the liquid cell. Alternatively or additionally, the liquid cell can also be movable and/or capable of being inclined, for example with the help of the manipulator. The manipulator can enable the illumination system, the detector system and the liquid cell to be moved and inclined relative to each other so that measurement and/or analysis is possible. For example, the manipulator can move and incline the liquid cell in the first cavity relative to the illumination system and the detector system.

The detector system can be configured to analyze the particles or radiation emitted from the liquid cell. The detector system can, for example, be a photoemission spectrometer. The detector system can include a front cap electrode, one or more electronic lenses, one or more deflectors, an analyzer and/or a detector. The detector system can, for example, be formed by the front cap electrode, the electronic lenses, the analyzer and the detector. The detector system can have one or more interconnected cavities forming an interior space of the detector system through which particles or radiation emitted from the liquid cell can be guided from the front cap electrode to the detector. In addition, the detector system can also include one or more deflectors to direct the particles or radiation to an input of the analyzer.

The front cap electrode can have a conical shape and an inlet opening which has a conical shape so that gas molecules entering the inlet opening can quickly disperse behind the inlet opening in the cavity enclosed by the front cap electrode. This enables a rapid pressure reduction. This can increase the free path length for electrons behind the inlet opening.

Different negative pressures can prevail in the multiple interconnected cavities, which pressures can decrease further from the inlet opening towards the detector. For this purpose, different pressure reduction stages can be provided and the pressure can be reduced by different amounts, for example by means of pumps with different pumping strengths in the cavities arranged one after the other. This can allow a lower pressure to be maintained in the detector system, for example in the case of an absolute pressure between 0.1 mbar and 100 mbar, e.g., 25 mbar, in the first cavity of the vacuum housing an absolute pressure in the range of 10⁻⁴ mbar to 10⁻² mbar, e.g., 10⁻³ mbar in the cavity enclosed by the front cap electrode, an absolute pressure of 10⁻⁶ mbar to 10⁻⁴ mbar, e.g., 10⁻⁵ mbar in a subsequent cavity and an absolute pressure in the range of 10⁻⁸ mbar to 10⁻⁵ mbar, e.g., 10⁻⁶ mbar, in the cavity in front of the detector.

For example, the analyzer can be a hemispherical energy analyzer or the analyzer can have one of these. The detector can, for example, have an electron multiplier, a phosphor screen, a video camera, a CCD sensor (charge-coupled device) and/or a CMOS sensor (complementary metal-oxide-semiconductor). The detector can also be configured as a DLD (delay line detector).

The inlet opening of the front cap electrode can, for example, be arranged above the liquid cell, in particular the opening in the cover of the liquid cell. The front cap electrode can, for example, also be inserted into the interior space of the liquid cell through the opening in the cover of the liquid cell. This can make it possible to position the inlet opening of the front cap electrode directly above the working electrode serving as the sample. The opening in the cover of the liquid cell can be configured in such a way that it allows particles or radiation, for example X-rays, to radiate from the illumination system into the liquid cell and to allow radiation or particles, for example electrons, to escape from the liquid cell through the opening. The cover of the liquid cell can make it possible to protect inner walls of the liquid cell, especially if they are made of PEEK or coated with PEEK, for example from charging during photoemission experiments.

A window transparent to electrons can be provided in the opening. This can, for example, be formed from a single-layer membrane, for example single-layer carbon, i.e., graphene. This can make it possible to set a pressure in the environment around the manipulator head in the vacuum housing that is different from the pressure in the interior space of the liquid cell.

The vacuum system can have a second cavity which is hermetically separated from the first cavity during operation. The first cavity can be configured for use with a different pressure range than the second cavity. This makes it possible, for example, to prepare the liquid cell for a measurement in the second cavity and to carry out a measurement in the first cavity.

The liquid can contain unwanted gases, such as oxygen (O₂), carbon monoxide (CO) or carbon dioxide (CO₂). The vacuum system can be configured to degas the liquid, for example to degas it thermally. This can make it possible to prevent or at least reduce unintentional degassing of the liquid in the liquid cell. The vacuum system can, for example, be configured to carry out pressure degassing, vacuum degassing, membrane degassing or chemical degassing. Preferably, the degassing is carried out outside the first cavity. This makes it possible to prevent or at least reduce the ingress of dirt into the first cavity and in particular into the liquid cell.

The vacuum system can include one or more liquid reservoirs for providing and/or collecting the liquid. The liquid reservoirs can be arranged in the first cavity or be fluidically connected to the first cavity. This can allow the liquid to be exchanged without having to break the negative pressure. This can make it possible to prevent or at least reduce the ingress of dirt into the first cavity and in particular into the liquid cell.

The vacuum system can include a potentiostat. The potentiostat can be connected to one or more of the electrodes of the electrochemical cell. This makes it possible to change the electrical potential within the electrochemical cell.

The vacuum system can include or be connected to a vacuum pump to create a negative pressure in the first cavity. The vacuum pump can be configured to generate a negative pressure in the first cavity. The vacuum pump can, for example, be configured to generate an absolute pressure between 0.1 mbar and 600 mbar, between 0.1 mbar and 400 mbar, or between 1 mbar and 100 mbar, for example 20 mbar. This makes it possible to generate different pressures in the vacuum system close to the ambient pressure, in particular close to atmospheric pressure, preferably close to the vapor pressure of the liquid used. The vacuum pump can, for example, be a diaphragm pump.

The first cavity can be filled with an inert gas. For example, the remaining air molecules in the first cavity can be replaced by inert gas molecules. The inert gas can, for example, contain or be a noble gas, e.g., argon, or a mixture of noble gases. The inert gas makes it possible to prevent chemical reactions between the inert gas and the liquid.

The vacuum housing can, for example, be made of stainless steel. The vacuum housing can have one or more shut-off valves to hermetically separate the first cavity from the environment of the vacuum housing.

The first cavity can, for example, have a volume between 0.0001 m³ and 1 m³, such as between 0.001 m³ and 0.1 m³, in particular a volume of 50 l.

The vacuum system can have a temperature control device. The temperature control device can contain one or more heaters and/or coolers. The temperature control device can be arranged on or in the liquid line, the movable shaft, a liquid supply line, the buffer cell, the liquid cell and/or the liquid pump. This makes it possible to control the temperature of the liquid, i.e., to heat or cool it, in order to set a desired temperature for the liquid at a specific position of the vacuum system. Different heating and cooling systems can also be provided at different positions in the vacuum system. This can make it possible to set different temperatures for the liquid at different positions in the vacuum system.

The temperature control device can have a temperature regulation that is configured to prevent the liquid from boiling. The temperature regulation can be connected to one or more sensors to acquire various parameters, such as pressure and temperature of the liquid and the environment of the liquid. This can make it possible to prevent the liquid from boiling so that the liquid can be prevented from splashing out of the liquid cell, thus preventing the manipulator head and the first cavity from becoming contaminated with liquid. In particular, the temperature control can make it possible to reduce the vapor pressure and thus enable the liquid cell to operate at a lower pressure.

According to a further aspect of the invention, a method for producing a manipulator head is provided. The method comprises the following steps:
providing a liquid cell with a liquid cell outlet and an interior space configured for negative pressure, which is configured to receive a liquid,
providing a liquid pump which has a liquid pumping region fluidically connected to the liquid cell outlet and which is configured to pump the liquid from the liquid pumping region when there is negative pressure in the interior space of the liquid cell, and
selecting a distance between the liquid cell outlet of the liquid cell and the liquid pumping region of the liquid pump such that, at an absolute pressure of below 600 mbar, for example below 400 mbar, in particular 100 mbar or less, the liquid extends in the interior space of the liquid cell at least into the liquid pumping region of the liquid pump so that the latter can pump the liquid.

The interior space of the liquid cell can be provided such that it is fluidically connected to an environment of the manipulator head, for example by providing an opening in the liquid cell to the environment of the manipulator head.

The liquid cell can be hermetically connected to the liquid pump.

In a further aspect, the invention also comprises a method for producing a vacuum system. The method for manufacturing a vacuum system includes, in addition to the steps for manufacturing a manipulator head, the following steps:
providing a vacuum housing for hermetically enclosing a first cavity at a negative pressure and
providing the manipulator head in the first cavity.

The method for manufacturing a vacuum system can also comprise a step of providing a manipulator. Additionally, or alternatively, the method for manufacturing a negative pressure system can also comprise the steps:
providing an illumination system configured to illuminate the liquid cell with particles or radiation, and
providing a detector system configured to receive particles or radiation emitted from the liquid cell.

According to a further aspect of the invention, a method for operating the vacuum system according to claim 10 or an embodiment of the vacuum system based on the vacuum system of claim 10 is provided. The method comprises the following steps:
generating an absolute pressure of below 600 mbar, for example below 400 mbar, in particular 100 mbar or less in the interior space of the liquid cell,
providing the liquid in the liquid cell,
pumping the liquid from the liquid pumping region of the liquid pump by means of the liquid pump so that the liquid is pumped out of the liquid cell,
arranging the liquid cell, the illumination system and the detector system in relation to one another such that the liquid cell can be illuminated with particles or radiation from the illumination system and radiation or particles can be received by the detector system,
illuminating the liquid cell with particles or radiation from the illumination system, and
detecting radiation or particles emitted from the liquid cell in the detector system.

The negative pressure in the interior space can be generated, for example, by generating negative pressure in the first cavity when the interior space of the liquid cell is fluidically connected to the first cavity.

The provision of the liquid in the liquid cell and the pumping of the liquid from the liquid pumping region of the liquid pump by means of the liquid pump can be carried out without the negative pressure having to be undone. This allows the liquid to be exchanged during operation of the vacuum system. The liquid can be exchanged at a negative pressure, in particular at an absolute pressure of below 600 mbar. The distance between the liquid cell outlet and the liquid pumping region can, for example, be selected such that, at an absolute pressure of below 600 mbar in the first cavity, the liquid extends at least into the liquid pumping region, so that the liquid pump can pump the liquid.

For example, the provision of the liquid in the liquid cell and the pumping of the liquid from the liquid pumping region by means of the liquid pump can be carried out continuously. This allows for continuous exchange of the liquid, for example of a water-based electrolyte.

The method of operating the vacuum system can comprise one or more of the steps:
moving and/or inclining the liquid cell by means of the manipulator in order to arrange the liquid cell, the illumination system and the detector system in relation to one another in such a way that the liquid cell can be illuminated with particles or radiation from the illumination system and radiation or particles can be received by the detector system,
providing the liquid in the liquid cell while pumping the liquid from the liquid pumping region of the liquid pump,
providing the liquid in the liquid cell and pumping the liquid from the liquid pumping region of the liquid pump so that a certain liquid level is kept constant within the interior space of the liquid cell,
providing the liquid in the liquid cell and pumping the liquid from the liquid pumping region of the liquid pump so that the liquid level within the interior space of the liquid cell is changed,
inclining the working electrode of the electrochemical cell so that a first part of the working electrode can protrude from the liquid during operation, a second part of the working electrode can be wetted by the liquid and a third part of the working electrode can be located within the liquid,
providing the liquid in the electrochemical cell and pumping the liquid from the liquid pumping region of the liquid pump such that a first part of the working electrode protrudes from the liquid during operation, a second part of the working electrode is wetted by the liquid and a third part of the working electrode is located within the liquid,
illuminating the working electrode of the electrochemical cell with particles or radiation from the illumination system so that the first part of the working electrode which protrudes from the liquid during operation, the second part of the working electrode which is wetted by the liquid and the third part of the working electrode which is located within the liquid are illuminated one after the other.

The liquid can be provided in such a way as to avoid boiling over of the liquid, for example by pumping at a limited pumping speed and/or pumping at a predetermined maximum pressure.

The method for operating the vacuum system can also comprise the steps:
providing the liquid in the liquid cell and pumping the liquid from the liquid pumping region of the liquid pump so that the liquid level within the liquid cell changes continuously and
illuminating the working electrode of the electrochemical cell with particles or radiation from the illumination system at a specific location on the working electrode while the liquid level within the liquid cell is continuously changing.

The continuous change can have a periodicity; for example, the liquid level can rise to a maximum liquid level, then fall to a maximum liquid level, and then rise again to the maximum liquid level.

According to a further aspect of the invention, a use of the vacuum system according to claim 10 or an embodiment of the vacuum system based on the vacuum system of claim 10 is provided for:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement,
a measurement of a supersaturated liquid.

Furthermore, according to a further aspect of the invention, a use of the method according to claim 12 or 13 or any embodiment of the method for operating the vacuum system according to claim 10 or an embodiment of the vacuum system based on the vacuum system of claim 10 is provided for:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement,
a measurement of a supersaturated liquid.

According to a further aspect of the invention, a computer program product is provided for operating the vacuum system according to claim 10 or an embodiment of the vacuum system based on the vacuum system of claim 10. The computer program product contains computer program code means that cause a processor to execute the method according to claim 12 or 13, or any embodiment of the method, when the computer program product is executed on the processor.

According to a further aspect, a computer-readable medium is provided having the computer program product stored thereon.

The manipulator head according to claim 1, the manipulator according to claim 7, the vacuum system according to claim 8, the vacuum system according to claim 9, the method according to claim 11, the method according to claim 13, the use according to claim 14 and the use according to claim 15 can have similar and/or identical preferred embodiments, as defined in particular in the dependent claims.

Furthermore, a preferred embodiment of the invention can also be any combination of the features of the dependent claims or the aforementioned embodiments in conjunction with the corresponding independent claim.

These and other aspects of the invention are explained in more detail below with reference to exemplary embodiments shown in the figures.

### BRIEF DESCRIPTION OF THE FIGURES

In the following figures:

FIG. 1 shows schematically and by way of example a first exemplary embodiment of the vacuum system in the form of a photoelectron spectroscopy system with a manipulator head fastened to a manipulator according to a first exemplary embodiment with an electrochemical cell;

FIG. 2 shows schematically and by way of example a manipulator head according to a second exemplary embodiment;

FIG. 3 shows schematically and by way of example a second exemplary embodiment of the vacuum system in the form of a photoelectron spectroscopy system with a manipulator head fastened in a vacuum housing according to a third exemplary embodiment;

FIG. 4 shows schematically and by way of example a manipulator head according to a fourth exemplary embodiment;

FIG. 5 shows an exemplary flow chart of an exemplary embodiment of the method for operating the vacuum system;

FIG. 6 shows an exemplary flow chart of an exemplary embodiment of a method for producing the manipulator head.

### DESCRIPTION OF THE EXEMPLARY EMBODIMENTS

The manipulator head described in the following on the basis of various exemplary embodiments, and the exemplary embodiments of a vacuum system with the manipulator head, as well as the method for operating the vacuum system, make it possible for liquids to be pumped out even at an absolute operating pressure of below 600 mbar, for example below 400 mbar, in particular 100 mbar or less, preferably in the range between 0.1 mbar and 100 mbar, e.g., between 10 mbar and 100 mbar. This means that a liquid cell can be emptied if necessary without increasing the operating pressure and the liquid in the liquid cell can be exchanged. Furthermore, a liquid level can be changed without changing the operating pressure in the liquid cell. This makes it possible to perform measurements at one location on a solid sample with different degrees of wetting of a liquid. Furthermore, for example, the liquid can be continuously exchanged without changing the liquid level. This allows, for example, the liquid outside the liquid cell to be changed, the changed liquid to be introduced into the liquid cell and the change in the liquid to be measured. Furthermore, it is possible to carry out longer measurements if a liquid is used up during the measurement, since the liquid can be refilled during the measurement without changing the measuring conditions.

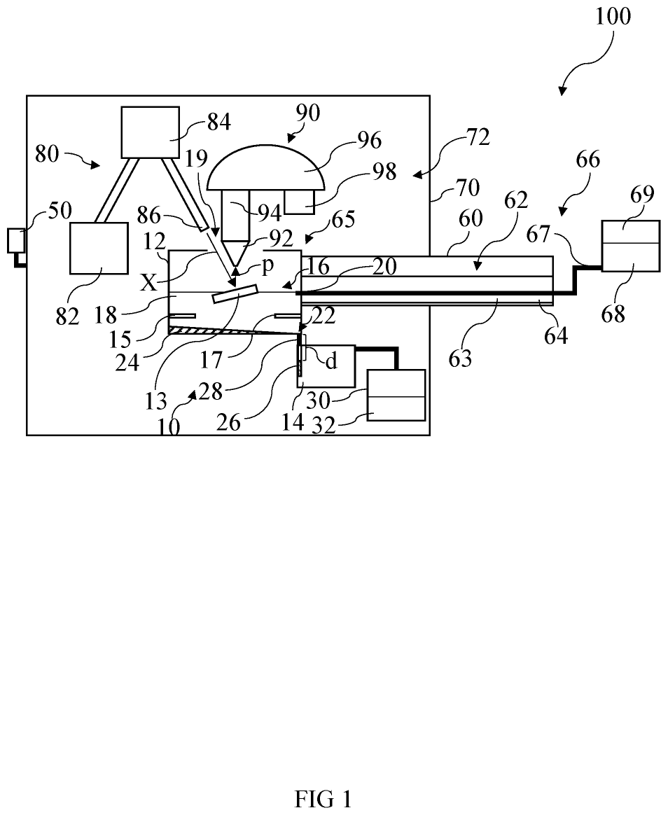

FIG. 1 shows schematically and by way of example a first embodiment of a vacuum system in the form of a photoelectron spectroscopy (PES) system 100. The PES system 100 can, for example, be used to perform measurements on a sample, e.g., a working electrode, and a liquid in the form of a water-based electrolyte at a pressure close to ambient pressure, in particular at an absolute pressure between 0.1 mbar and 100 mbar. Here, radiation is radiated onto the sample and the liquid and photoelectrons generated by the radiation are detected.

The PES system 100 includes a manipulator head 10, a vacuum pump 50, a manipulator 60, a vacuum housing 70 in the form of a vacuum chamber, an illumination system 80 in the form of a monochromatized aluminum (Al) X-ray source and a detector system 90. Instead of an aluminum X-ray source, another X-ray source, such as a silver (Ag) or chromium (Cr) X-ray source or an X-ray source providing multiple wavelengths, can be used.

The manipulator head 10 is configured for use in the vacuum housing 70 at negative pressure, for example in the range between 0.1 mbar and 600 mbar. For this purpose, materials specially configured for such pressures are used to manufacture the manipulator head.

In this exemplary embodiment, the manipulator head 10 contains a liquid cell 12 in the form of an electrochemical cell and a liquid pump 14 in the form of a peristaltic pump (details not shown). Alternatively, another type of liquid pump can be used, in particular another type of positive displacement pump. Multiple liquid pumps can also be provided.

The liquid cell 12 has an interior space 16 configured for negative pressure, which is configured to hold a liquid 18 in the form of the water-based electrolyte. The interior space 16 is fluidically connected to the environment of the manipulator head 10 via an opening 19. In this embodiment, the liquid cell 12 has three electrodes 13, 15, and 17, namely a working electrode 13, a counter-electrode 15, and a reference electrode 17. In other embodiments, a different number of electrodes can be provided, for example 2 or 4. The liquid 18 can be introduced into the liquid cell 12 via a liquid cell inlet 20 and discharged from the liquid cell 12 via a liquid cell outlet 22. In this embodiment, the liquid cell outlet 22 is arranged at a lowest point of the interior space 16 of the liquid cell 12, namely a lowest point of a base 24 of the liquid cell 12. In other embodiments, the liquid cell outlet can also be arranged, for example, in another bottom region of the liquid cell, e.g., on a wall of the liquid cell with contact to the base. Furthermore, in this embodiment, the base 24 of the liquid cell 12 has an inclination in the direction of the liquid cell outlet 16 with an inclination angle of 10°. In other embodiments, the base can also be configured without an incline or with a different incline, for example an incline in the direction of the liquid cell outlet with an inclination angle between 2° and 20°, so that the liquid flows in the direction of the liquid cell outlet and thus flows better out of the liquid cell.

The liquid pump 14 has a liquid pumping region 26 which is fluidically connected to the liquid cell outlet 22. For this purpose, the liquid cell outlet 22 is connected to the liquid pumping region 26 via a liquid line 28 in the form of a hose made of PEEK. The liquid pump 14 is configured to pump the liquid 18 out of the liquid pumping region 26 when there is negative pressure in the interior space 16 of the liquid cell 12. In this embodiment, the liquid line 28 extends through the liquid pump 14 into a liquid reservoir 30 in which pumped liquid 32 can be stored. For a better overview, the liquid line 28 is only partially shown inside the liquid pump 14. The liquid pump 14 has rollers (not shown) that can press on the liquid line 28 within the liquid pump 14 so that the liquid 18 can be pumped through the liquid line 28 in portions by moving the rollers. The rollers can only press on the liquid line from a pressing position, which in this case marks the beginning of the liquid pumping region 26.

A distance d between the liquid cell outlet 22 of the liquid cell 12 and the liquid pumping region 26 of the liquid pump 14 is selected such that, at an absolute pressure in the range between 0.1 mbar and 100 mbar, the liquid 18 extends in the interior space 16 of the liquid cell 12 at least into the liquid pumping region 26, so that the liquid pump 14 can pump the liquid 18. In other words, the goal is to make the distance between the liquid cell outlet of the liquid cell and the liquid pumping region of the liquid pump short enough that the pressure loss is smaller than the pressure difference between the liquid cell outlet and the liquid pumping region. In this embodiment, the distance d is a vertical distance. In other embodiments, the distance can also be composed of a vertical distance and a horizontal distance. In other embodiments, the distance between the liquid cell outlet and the liquid pumping region can also be selected such that, at an absolute pressure in the range of below 600 mbar, for example below 400 mbar, in particular 100 mbar or less, the liquid extends at least into the liquid pumping region so that the liquid pump can pump the liquid.

In this embodiment, the liquid outlet 22 and the liquid line 28 have a constant inner diameter of 2.8 mm each. In other embodiments, the inner diameters can also be of different sizes and can be, for example, between 1 mm and 4 mm, for example 2 mm. In further embodiments, the inner diameter of the liquid line can be adapted to an application, in particular a viscosity of the liquid.

The distance d between the liquid cell outlet 22 and the liquid pumping region 26 is 12 mm in this embodiment. In this case, a length of a liquid line portion between the liquid cell outlet 22 and the liquid pumping region 26 is also 12 mm. In other embodiments, the distance can also be, for example, between 1 mm and 200 mm.

The vacuum pump 50 can pump gas out of the vacuum housing 70 so that a negative pressure can be generated in a first cavity 72 of the vacuum housing 70. The negative pressure in this case is an absolute pressure between 0.1 mbar and 100 mbar, for example 0.5 mbar, 1 mbar, or 2 mbar. In other embodiments, the negative pressure can, for example, be an absolute pressure below 600 mbar, below 400 mbar, or 100 mbar or less.

The manipulator 60 has a manipulator interior space 62 and a movable shaft 64. The shaft 64 is also rotatable. The manipulator 60 is hermetically connected to the vacuum housing 70. The movable shaft 64 has a distal end 65 and a proximal end 66. The distal end 65 is arranged in the first cavity 72 of the vacuum housing 70 and the proximal end 66 is located outside the vacuum housing 70. A liquid supply line 67 from a liquid reservoir 69 runs through a lumen 63 running through the movable shaft 64. A supply liquid 68 is stored in the liquid reservoir 69 and can be introduced into the liquid cell 12. For this purpose, the liquid supply line 67 is connected to the liquid cell 12 via the liquid cell inlet 20. The manipulator head 10 is attached to the distal end 65 of the movable shaft 64 of the manipulator 60. When the manipulator 60 is connected to the vacuum housing 70, the movable shaft 64 can be moved and inclined in the first cavity 72 of the vacuum housing 70, so that the manipulator head 10 is arranged in the first cavity 72 of the vacuum housing 70.

The illumination system 80 contains an X-ray source 82. In the X-ray source 82, an electron gun accelerates electrons onto an Al anode (not shown). The electrons striking the Al anode generate X-rays, which are monochromatized by the monochromator 84. The monochromatized X-ray radiation X exits from a monochromator outlet 86 and radiates onto the working electrode 13 to excite photoelectrons p. In other embodiments, the illumination system can also generate other radiation or particles and illuminate the liquid cell with these.

The photoelectrons p are analyzed in the detector system 90. For this purpose, the detector system 90 contains a front cap electrode 92, a lens system 94, a hemispherical energy analyzer 96 and a detector 98.

The front cap electrode 92 has the smallest possible distance from the working electrode 13 of the liquid cell 12, for example in the range of 0.2 mm to 0.5 mm, so that as many as possible of the photoelectrons p emitted by the working electrode 13 of the liquid cell 12 can enter an inlet opening of the front cap electrode 92 of the lens system 94. In this embodiment, the front cap electrode has a conical shape. This allows for rapid pressure reduction within the lens system 94. In addition, further vacuum pumps are provided which reduce the pressure within multiple consecutive cavities of the lens system 94 (not shown). This makes it possible to maintain an operating pressure of, for example, 0.1 mbar to 100 mbar in the first cavity 72, while in a cavity in front of the detector 98 there prevails only an absolute pressure of 10⁻⁸ mbar to 10⁻⁵ mbar, e.g., 10⁻⁶ mbar. This makes it possible to reduce the loss of photoelectrons due to collisions with gas molecules, so that the signal quality can be increased.

The lens system 94 serves to transmit the photoelectrons p to the hemispherical energy analyzer 96 and to focus them so that the hemispherical energy analyzer 96 can separate the photoelectrons p according to their kinetic energies. For this purpose, the lens system 94 can contain various electron optical lenses and/or deflectors (not shown). The photoelectrons p can then be detected by a detector 98. The detector 98 can, for example, be a CMOS detector. Impact positions of the photoelectrons p measured by the detector 98 can then be assigned to a corresponding kinetic energy in order to analyze the photoelectrons p.

In other exemplary embodiments, the detector system can also be configured to receive and analyze other particles or radiation emitted from the liquid cell.

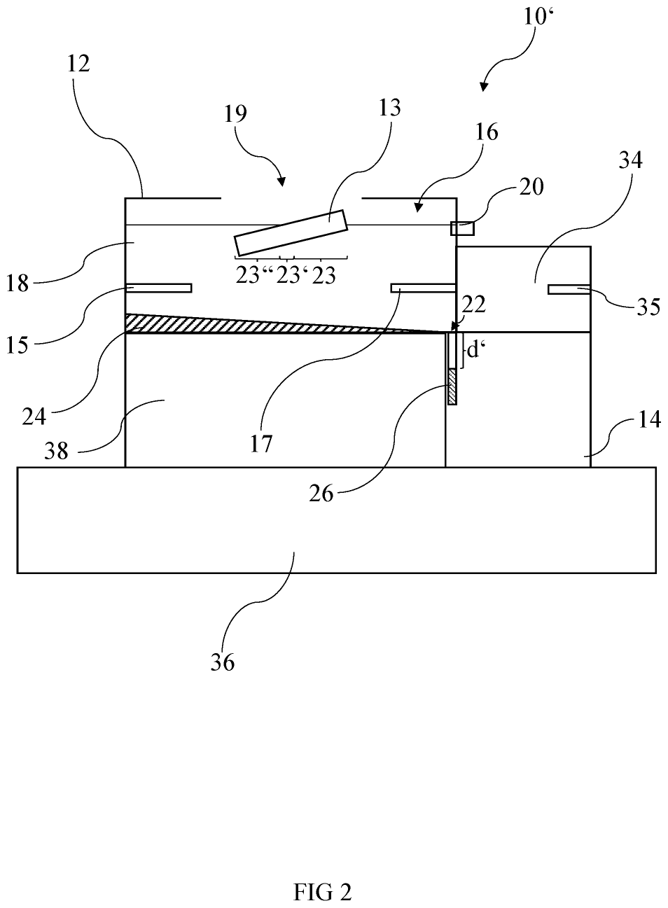

FIG. 2 shows schematically and by way of example a manipulator head 10′ according to a second exemplary embodiment. The manipulator head 10′ contains a liquid cell 12 in the form of an electrochemical cell, a liquid pump 14 in the form of a peristaltic pump, a fastening device 34, a buffer cell 36 and a temperature control device 38. Components identical to other embodiments are designated by identical reference numerals.

The liquid cell 12 has a working electrode 13, a counter-electrode 15, and a reference electrode 17. The working electrode 13 is arranged at an inclination to the liquid surface of the liquid 18 in the electrochemical cell 12. The inclination is selected such that a first part 23 of the working electrode 13 protrudes from the liquid 18, a second part 23′ of the working electrode 13 is wetted by the liquid 18 and a third part 23″ of the working electrode 13 is located within the liquid 18. In other embodiments, a relative inclination angle of the working electrode to the liquid surface can also be changed by means of an inclination device. In another embodiment, for example, the entire liquid cell can be inclined so that the working electrode is inclined relative to the liquid surface. The manipulator head and thus also the liquid cell can, for example, be inclined by a manipulator by rotating its movable shaft by a certain angle.

Furthermore, the liquid cell 12 has an opening 19 which connects an interior space 16 of the liquid cell 12 with the environment. The working electrode 13 is arranged below the opening 19 so that a detector system can be moved to the working electrode 13, or the working electrode 13 can be moved to the detector system.

The liquid cell 12 has a liquid cell inlet 20 for introducing the liquid 18 and a liquid cell outlet 22 for discharging the liquid 18 from the liquid cell 12. Also in this embodiment, the base 24 is provided with an incline so that the liquid 18 flows in the direction of the liquid cell outlet 22. In this embodiment, the liquid pump 14 is directly connected to the liquid cell outlet 22. The distance d′ between the liquid cell outlet 22 and the liquid pumping region in this case corresponds to a wall thickness of the housing part that forms the liquid cell outlet 22 and to a short liquid line region in front of a pressure position at which the liquid pumping region 26 begins. In this case the distance d′ is for example 1 mm.

The fastening device 34 can be fastened to a manipulator. In this embodiment, the fastening device 34 contains a threaded hole 35 into which a screw can be screwed in order to fasten the manipulator head 10 to a shaft of a manipulator.

The buffer cell 36 is open at the top so that liquid 18 splashing down from the liquid cell 12 can be collected in the buffer cell 36.

The tempering device 38 is arranged between the liquid cell 12 and the buffer cell 36 and contains heaters and coolers to control the temperature of the liquid cell 12 and the buffer cell 36.

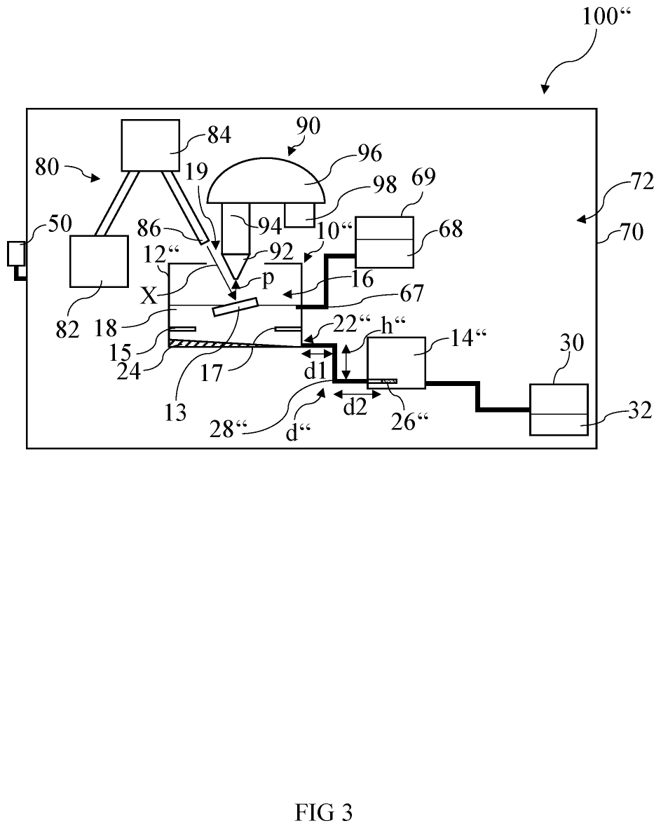

FIG. 3 shows schematically and by way of example a second embodiment of the vacuum system in the form of a PES system 100″. The PES system 100″ is similar to the PES system 100 shown in FIG. 1. Reference numerals identical to the other embodiments are used for identical components, and for the description of the function of these components reference is made to the description of FIG. 1.

The PES system 100″ includes a manipulator head 10″, a vacuum pump 50, a vacuum housing 70 in the form of a vacuum chamber, an illumination system 80 in the form of a monochromatized Al X-ray source, and a detector system 90.

In contrast to the PES system 100, the manipulator head 10″ in the PES system 100″ is fastened in the vacuum housing 70 and not at the distal end of a manipulator. In this embodiment, the manipulator head 10″ thus cannot be moved with the manipulator. In order to align the illumination system 80 and the detector system 90 with the working electrode 13 of the liquid cell 12″ of the manipulator head 10″, in this exemplary embodiment the illumination system 80 and the detector system 90 must therefore be moved accordingly and, if necessary, inclined. Appropriate actuators (not shown) are provided for this purpose. Alternatively, for example, one or more deflectors can also be provided which can direct the beam or particles from the illumination system onto the working electrode (not shown). Furthermore, in this embodiment the first liquid reservoir 69 is also located within the vacuum housing 70, so that the liquid supply line 67 also runs completely within the first cavity 72 of the vacuum housing 70.

The manipulator head 10″ contains the liquid cell 12″ and the liquid pump 14″, which are connected to each other via a liquid line 28″.

The liquid cell outlet 22″ of the liquid cell 12″ is arranged in the bottom area on a wall of the liquid cell 12″. In this embodiment, the distance d″ of the liquid cell outlet 22″ of the liquid cell 12″ to the liquid pumping region 26″ of the liquid pump 14″ is composed of the horizontal distances d1 and d2 and the vertical distance h″. Due to the vertical distance h″, an additional hydrostatic pressure acts through the liquid column of the liquid 18. The distance d″ is selected such that the acting pressure is greater than the pressure loss between the liquid cell outlet 22″ and the liquid pumping region 26″, in particular along the liquid line 28″, so that the liquid 18 extends into the liquid pumping region 26″ and the liquid pump 14″ can pump the liquid 18.

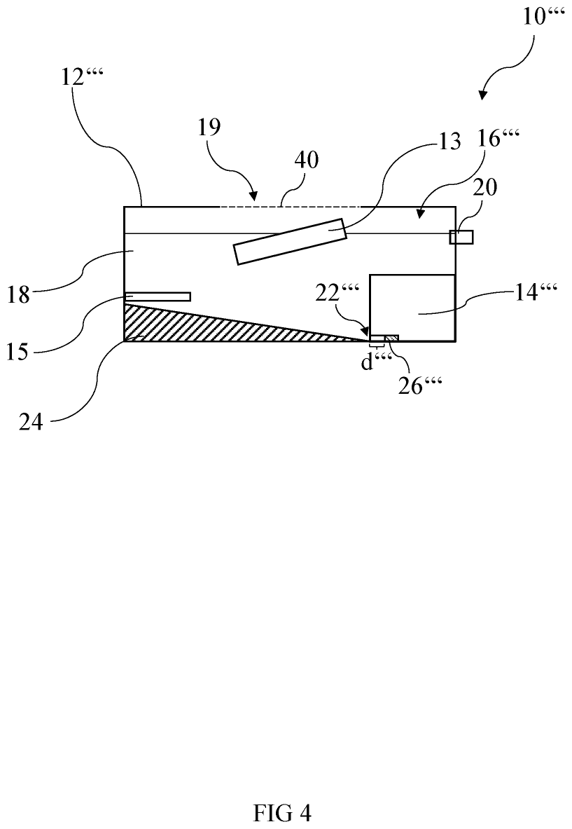

FIG. 4 shows schematically and by way of example a manipulator head 10′″ according to a fourth embodiment.

The manipulator head 10′″ contains a liquid cell 12′″ and a liquid pump 14′″. In this embodiment, the liquid cell 12′″ and the liquid pump 14′″ are arranged in a common housing.

In the housing there is an opening 19 which is separated from the surrounding environment of the manipulator head 10′″ by a transparent window 40 in the form of a layer of graphene. This makes it possible to prevent liquid 18 from escaping through the opening 19. Furthermore, this makes it possible to set a different pressure in the environment of the manipulator head 10′″ and within the interior space 16′″. For example, the pressure in the liquid cell 12′″ can be higher than in the environment surrounding the manipulator head 10′″. Alternatively, another transparent window can be provided which is transparent to the radiation and particles emanating from the illumination system and emitted from the liquid cell 12′″. Transparent here does not mean that there can be no losses in the transparent window, but that the transmission is relatively high, for example over 90%. Furthermore, instead of one opening, multiple openings with multiple transparent windows can be provided, for example one opening for the radiation or particles radiating onto the liquid cell and one opening for particles or radiation emitted from the liquid cell. In this case, the transparent windows can also be made of different materials, each of which is transparent to the radiation or particles passing through them.

The liquid cell 12′″ contains an inclined working electrode 13 and a counter-electrode 15. Liquid 18 is introduced into the interior space 16′″ of the liquid cell 12′″ via the liquid cell inlet 20 and is introduced from the liquid cell 12′″ into the liquid pumping region 26′″ of the liquid pump 14′″ via the liquid cell outlet 22′″. A base 24 with an inclination ensures that the liquid 18 flows into the liquid cell outlet 22′″. The distance d′″ between the liquid cell outlet 22′″ of the liquid cell 12′″ and the liquid pumping region 26′″ of the liquid pump 14′″ is in this case a horizontal distance. The distance d′″ is selected such that the liquid 18 extends into the liquid pumping region 26′″ and the liquid pump 14′″ can pump the liquid 18.

In other embodiments, the liquid cell can also be inclined to allow liquid to flow into the liquid cell outlet. In this case, the liquid cell outlet can also be located on a wall of the liquid cell, in particular without contact with the base. Preferably, the liquid cell outlet is arranged in the wall such that when the liquid cell is inclined, the liquid cell outlet is located at a lowest point of the interior space of the liquid cell so that the liquid flows out of it. In this case, the inclination can be selected so that the working electrode is aligned with the illumination system and the detector system and a measurement can be made.

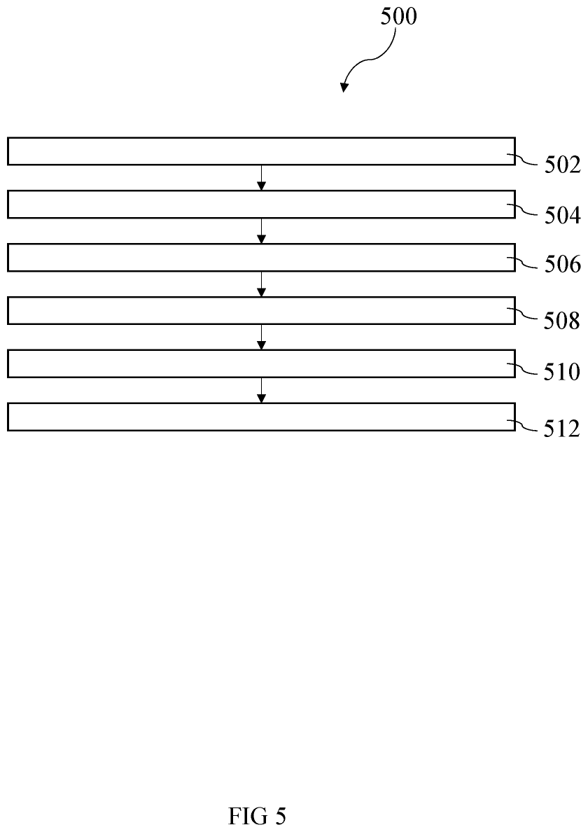

FIG. 5 shows an exemplary flow chart of an exemplary embodiment of a method 500 for operating a vacuum system. For example, the vacuum system shown in FIG. 1 or FIG. 3 can be operated according to the method.

In step 502, an absolute pressure between 0.1 mbar and 100 mbar, for example 25 mbar, is generated in the interior space of the liquid cell. For this purpose, the vacuum pump is used to pump gas out of the first cavity of the vacuum housing, which is fluidically connected to the interior space of the liquid cell. In other embodiments, for example, an absolute pressure of below 600 mbar, below 400 mbar, or 100 mbar or less, for example from 1 mbar to below 600 mbar, from 1 mbar to below 400 mbar, or from 1 mbar to 100 mbar, can be generated in the interior space of the liquid cell.

In step 504, the liquid is provided in the liquid cell. For this purpose, the liquid is introduced into the liquid cell via the liquid cell inlet. This liquid extends as far as the liquid pumping region of the liquid pump so that the liquid pump can pump the liquid to circulate the liquid or to empty the liquid cell.

In step 506, the liquid is pumped from the liquid pumping region of the liquid pump by the liquid pump so that the liquid is pumped out of the liquid cell. Since in this embodiment liquid is simultaneously supplied to the liquid cell via the liquid cell inlet, a constant exchange of the liquid can take place. In other words, in this exemplary embodiment steps 504 and 506 are carried out in such a way that a certain liquid level is kept constant within the interior space of the liquid cell.

In other embodiments, the liquid in the liquid cell can also be provided and the liquid can also be pumped out of the liquid pumping region of the liquid pump such that the liquid level within the interior space of the liquid cell changes, for example changes continuously and/or periodically. This can make it possible to carry out measurements at different liquid levels at one measuring point.

In alternative embodiments, the liquid cell can for example also be emptied after a measurement in order to fill it with another liquid.

In step 508, the liquid cell, the illumination system and the detector system are arranged relative to one another such that the liquid cell can be illuminated with the X-rays from the illumination system and the photoelectrons can be received by the detector system. In other embodiments, other radiation or particles can be provided by the illumination system and the detector system can detect other particles or radiation.

In the case of the PES system shown in FIG. 1, the liquid cell is moved and inclined with the aid of the manipulator so that a radiation spot of the illumination system is aligned with a point to be measured on the working electrode of the liquid cell and an inlet opening into the detector system is located over the radiation spot so that the photoelectrons can enter into it.

In other embodiments, for example in the case of the PES system shown in FIG. 3, the illumination system and the detector system can be moved and inclined such that a radiation spot of the illumination system is aligned with a point to be measured on the working electrode of the liquid cell and an inlet opening into the detector system is located above the radiation spot so that the photoelectrons can enter it.

In step 510, the liquid cell, or the point on the working electrode of the liquid cell to be measured, is illuminated with the X-ray radiation of the illumination system. This generates photoelectrons that enter the detector system. In order to generate the highest possible number of photoelectrons that can enter the detector system, various parameters of the illumination system can be optimized.

In other embodiments, the liquid cell can also be irradiated with other radiation or particles to generate radiation or particles.

Instead of the working electrode, another electrode of the liquid cell can be irradiated, or the liquid or the working electrode wetted with liquid. For example, the working electrode can be inclined so that the liquid creates a meniscus on the surface of the working electrode, so that the measurement of the working electrode can be carried out through a thin film of liquid.

The working electrode can also be inclined so that a first part of the working electrode protrudes from the liquid, a second part of the working electrode is wetted by the liquid and a third part of the working electrode is located within the liquid. The liquid can also be provided in the electrochemical cell and the liquid can be pumped out of the liquid pumping region of the liquid pump in such a way that a first part of the working electrode protrudes from the liquid during operation, a second part of the working electrode is wetted by the liquid and a third part of the working electrode is located within the liquid. In this case, for example, the working electrode can be illuminated with particles or radiation from the illumination system in such a way that the first part of the working electrode protruding from the liquid, the second part of the working electrode wetted by the liquid and the third part of the working electrode located within the liquid are illuminated one after the other. For this purpose, the spot on the working electrode can be moved. Alternatively, the liquid can be pumped in such a way that the liquid level changes so that the measurements with liquid film and without liquid film on the working electrode can be carried out one after the other at the same measuring point, for example by increasing the liquid level in the liquid cell.

In step 512, the photoelectrons emitted from the liquid cell or from the point to be measured on the working electrode of the liquid cell are detected in the detector system. In order to detect the photoelectrons in the detector system, various parameters of the detector system can be optimized.

In other exemplary embodiments, other particles or radiation can also be detected in the detector system.

The vacuum systems 100 and 100′ shown in FIGS. 1 and 3, as well as the method shown in FIG. 5, can be used for example for a surface analysis, a measurement of a surface reaction, a measurement of liquid-solid reactions, a measurement of liquid-gas reactions, a measurement of liquids, a measurement of thin layers, a detection of foreign substances in liquids, a photoemission measurement, a photoelectron spectroscopy measurement close to atmospheric pressure, an X-ray photoelectron spectroscopy measurement close to atmospheric pressure, an electrochemical measurement, a battery analysis, an oxidation measurement, an electrolyte measurement, an electrode measurement, a sample measurement through a liquid, a quality control, a corrosion measurement, a catalyst measurement, a pressure-dependent measurement, a measurement of a biological sample, a potentiometry measurement, and/or a measurement of a supersaturated liquid.

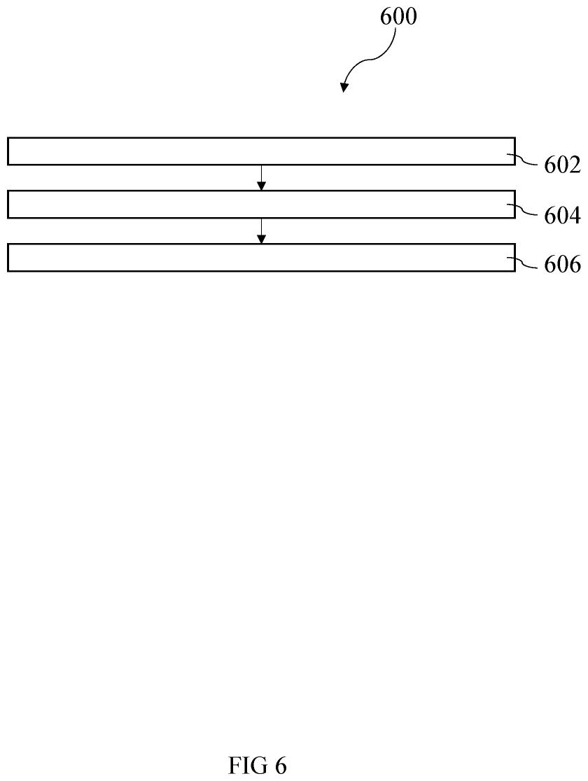

FIG. 6 shows an exemplary flow chart of an embodiment of a method 600 for manufacturing the manipulator head. For example, one of the exemplary embodiments of the manipulator head 10, 10′, 10″, or 10′″ shown in FIGS. 1, 2, 3, and 4 can be manufactured.

In step 602, a liquid cell in the form of an electrochemical cell is provided. For this purpose, a housing with four side walls and a base is provided, which enclose an interior space that can accommodate a liquid, in particular a water-based electrolyte. Additionally, the case has a cover with an opening. The housing is suitable for operation at a negative pressure, in particular at an absolute pressure of below 600 mbar, for example an absolute pressure of 100 mbar or less. Optionally, multiple electrodes can be provided in the liquid cell, for example a working electrode, a reference electrode, and a counter-electrode.

Furthermore, the liquid cell has a liquid cell inlet for introducing liquid into the liquid cell and a liquid cell outlet for removing liquid from the liquid cell. In this exemplary embodiment, the liquid cell outlet is arranged in the base of the liquid cell at a lowest point of the base so that it can serve as an outlet for the liquid, similar to a bathtub drain. This allows the liquid cell to be completely emptied. Optionally, the base is inclined towards the liquid cell outlet, for example with an inclination angle of 10°.

Since at an absolute pressure of below 600 mbar the liquid would not flow away through a liquid line by itself—depending on the liquid line inner diameter, viscosity of the liquid, and length of the liquid line—a liquid pump must also be provided to pump out the liquid.

In step 604, a liquid pump in the form of a peristaltic pump is provided. The liquid pump has a liquid pumping region. In this embodiment, the liquid pumping region is formed by a part of a liquid line in the form of an elastic hose made of PEEK. The liquid pumping region in this embodiment extends from a first pressing point of a roller of the liquid pump to a second point which corresponds to a distance between the rollers, so that when the roller presses the hose, liquid is transported along the hose by the movement of the roller. In other words, the liquid pump can pump the liquid that extends into the liquid pumping region of the liquid pump.

In step 606, a distance between the liquid cell outlet of the liquid cell and the liquid pumping region of the liquid pump is selected such that at an absolute pressure between 1 mbar and 100 mbar in the interior space of the liquid cell, the liquid extends at least into the liquid pumping region so that the liquid pump can pump the liquid. This ensures that the liquid can be pumped out of the liquid pumping region. In other exemplary embodiments, the distance between the liquid cell outlet and the liquid pumping region can also be selected such that, at an absolute pressure of below 600 mbar, below 400 mbar or 100 mbar or less in the interior space of the liquid cell, the liquid extends at least into the liquid pumping region, so that the liquid pump can pump the liquid.

The distance can be composed of a vertical and a horizontal distance.

For example, for fixed other parameters, such as liquid line inner diameter, material of the liquid line, desired absolute pressure in the interior space of the liquid cell, and viscosity of the liquid, the distance between the liquid cell outlet and the liquid pumping region can be reduced until the liquid pump can pump the liquid. For example, a length of the liquid line between the liquid cell outlet and the liquid pumping region can be reduced until liquid can be pumped. This can be done experimentally, but can also be calculated, for example by simulation or based on the Bernoulli equation.

The description of the invention given above in conjunction with the drawings serves to explain the features of the invention in the form of exemplary embodiments. However, the features explained in the exemplary embodiments are only given by way of example and should not be understood as limiting. In particular, the invention is not limited to the exemplary embodiments or the combination of features of individual exemplary embodiments. For example, it is also possible to operate the invention, in one exemplary embodiment, with a different illumination system, for example with a synchrotron radiation source or another detector system.

Other variants and variations of the exemplary embodiments shown can be understood and implemented by the person skilled in the art by reproducing the claimed invention in view of the figures, description and claims.

The words “containing,” “comprising,” “having,” do not exclude further elements, components or steps, and the indefinite articles “a” or “an” do not exclude a plurality.

The fact that particular means are mentioned in different claims should not be understood to mean that a combination of these means cannot be used advantageously.

The reference symbols used in the claims are not to be understood as limiting the features of the embodiments, but merely as exemplary for the features of the claims.

The invention relates to pumping liquids in a vacuum system at a negative pressure, in particular at an absolute pressure of below 600 mbar. For this purpose, a manipulator head is provided for use in a vacuum housing under negative pressure. The manipulator head contains a liquid cell and a liquid pump. The liquid cell has a liquid cell outlet and a interior space configured for negative pressure and configured to receive a liquid. The liquid pump has a liquid pumping region fluidically connected to the liquid cell outlet and is configured to pump the liquid from the liquid pumping region when there is a negative pressure in the interior space of the liquid cell. A distance between the liquid cell outlet of the liquid cell and the liquid pumping region of the liquid pump is selected such that at an absolute pressure of below 600 mbar in the interior space of the liquid cell, the liquid extends at least as far as the liquid pumping region of the liquid pump so that the latter can pump the liquid. This enables a compact design for a vacuum system that can circulate liquid at an absolute pressure of below 600 mbar and, in particular, can also be drained.

1. A manipulator head, wherein the manipulator head is configured for use in a vacuum housing at a negative pressure and has:
a liquid cell with a liquid cell outlet and an interior space configured for negative pressure, which is configured to receive a liquid, and
a liquid pump which has a liquid pumping region fluidically connected to the liquid cell outlet and which is configured to pump the liquid out of the liquid pumping region when there is negative pressure in the interior space of the liquid cell,
wherein a distance between the liquid cell outlet of the liquid cell and the liquid pumping region of the liquid pump is selected such that at an absolute pressure of below 600 mbar, the liquid extends in the interior space of the liquid cell at least into the liquid pumping region of the liquid pump, so that the liquid pump can pump the liquid.

2. The manipulator head according to claim 1, wherein the liquid cell outlet is arranged in a bottom region of the liquid cell, in particular at a lowest point of the interior space of the liquid cell, and wherein the liquid cell outlet of the liquid cell is arranged relative to the liquid pump region of the liquid pump with a vertical distance which is selected such that, at an absolute pressure of below 600 mbar, the liquid extends in the interior space of the liquid cell at least into the liquid pump region of the liquid pump so that the latter can pump the liquid.

3. The manipulator head according to claim 1, wherein a base of the liquid cell has an inclination in a direction of the liquid cell outlet and wherein the inclination is selected such that the liquid flows in the direction of the liquid cell outlet.

4. The manipulator head according to claim 1, wherein the liquid pump has a positive displacement pump.

5. The manipulator head according to claim 1, wherein the liquid cell is an electrochemical cell having a working electrode and a counter-electrode.

6. The manipulator head according to claim 5, wherein the working electrode is arranged with an inclination to a liquid surface in the electrochemical cell, which is selected such that a first part of the working electrode can protrude from the liquid during operation, a second part of the working electrode can be wetted by the liquid and a third part of the working electrode can be located within the liquid.

7. A manipulator with a manipulator interior space which is configured to be hermetically connected to a vacuum housing, wherein the manipulator has a movable shaft with a distal end which can be moved in a cavity of the vacuum housing when the manipulator is connected to the vacuum housing, wherein the distal end of the movable shaft comprises the manipulator head according to claim 1, so that the manipulator head is arranged in the cavity of the vacuum housing when the manipulator is connected to the vacuum housing.

8. A vacuum system comprising:
a vacuum housing for hermetically enclosing a first cavity at a negative pressure and
the manipulator head according to claim 1.

9. A vacuum system comprising:
a vacuum housing for hermetically enclosing a first cavity at a negative pressure and
the manipulator according to claim 7.

10. The vacuum system according to claim 8, further comprising:
an illumination system configured to illuminate the liquid cell with particles or radiation and
a detector system configured to receive particles or radiation emitted from the liquid cell.

11. A method for manufacturing a manipulator head, comprising the steps:
providing a liquid cell with a liquid cell outlet and an interior space configured for negative pressure, which is configured to receive a liquid,
providing a liquid pump which has a liquid pumping region fluidically connected to the liquid cell outlet and which is configured to pump the liquid from the liquid pumping region when there is negative pressure in the interior space of the liquid cell, and
selecting a distance between the liquid cell outlet of the liquid cell and the liquid pumping region of the liquid pump such that, at an absolute pressure of below 600 mbar, the liquid extends in the interior space of the liquid cell at least into the liquid pumping region of the liquid pump so that the liquid pump can pump the liquid.

12. A method for operating the vacuum system according to claim 10, comprising the steps:
generating an absolute pressure of below 600 mbar in the interior space of the liquid cell,
providing the liquid in the liquid cell,
pumping the liquid from the liquid pumping region of the liquid pump by use of the liquid pump so that the liquid is pumped out of the liquid cell,
arranging the liquid cell, the illumination system and the detector system in relation to one another such that the liquid cell can be illuminated with particles or radiation from the illumination system and radiation or particles can be received by the detector system,
illuminating the liquid cell with particles or radiation from the illumination system, and
detecting radiation or particles emitted from the liquid cell in the detector system.

13. The method according to claim 12, wherein the liquid cell is an electrochemical cell having a working, electrode and a counter-electrode, and the method further comprises one or more of the steps:
moving and/or inclining the liquid cell by use of the manipulator in order to arrange the liquid cell, the illumination system and the detector system in relation to one another in such a way that the liquid cell can be illuminated with particles or radiation from the illumination system and radiation or particles can be received by the detector system,
providing the liquid in the liquid cell while pumping the liquid from the liquid pumping region of the liquid pump,
providing the liquid in the liquid cell and pumping the liquid from the liquid pumping region of the liquid pump so that a certain liquid level is kept constant within the interior space of the liquid cell,
providing the liquid in the liquid cell and pumping the liquid from the liquid pumping region of the liquid pump so that the liquid level within the interior space of the liquid cell is changed,
inclining the working electrode of the electrochemical cell so that a first part of the working electrode can protrude from the liquid during operation, a second part of the working electrode can be wetted by the liquid and a third part of the working electrode can be located within the liquid,
providing the liquid in the electrochemical cell and pumping the liquid from the liquid pumping region of the liquid pump such that a first part of the working electrode protrudes from the liquid during operation, a second part of the working electrode is wetted by the liquid and a third part of the working electrode is located within the liquid, and
illuminating the working electrode of the electrochemical cell with particles or radiation from the illumination system so that the first part of the working electrode which protrudes from the liquid during operation, the second part of the working electrode which is wetted by the liquid and the third part of the working electrode which is located within the liquid are illuminated one after the other.

14. The vacuum system according to claim 10, which is configured for:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement, or
a measurement of a supersaturated liquid.

15. The method according to claim 12, further comprising performing at least one of the following steps:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement, and
a measurement of a supersaturated liquid.
